(19) United States
(12) Patent Application Publication
(10) Pub. No.: US 2018/0139413 A1
(43) Pub. Date: May 17, 2018

(54) METHOD AND SYSTEM TO ACCOMMODATE CONCURRENT PRIVATE SESSIONS IN A VIRTUAL CONFERENCE

(71) Applicant: Jie DIAO, Fremont, CA (US)

(72) Inventor: Jie DIAO, Fremont, CA (US)

(21) Appl. No.: 15/816,572

(22) Filed: Nov. 17, 2017

Related U.S. Application Data
(60) Provisional application No. 62/423,706, filed on Nov. 17, 2016.

(51) Int. Cl. H04N 7/15; H04L 29/06; H04M 3/56

(52) U.S. Cl. CPC H04N 7/155; H04L 65/1089; H04L 65/1093; H04M 3/566; H04L 65/403; H04L 65/4015; H04L 65/1069; H04L 65/601

(57) ABSTRACT

A virtual conference system that allows private sessions to happen simultaneously as and within the public conference is presented. The system allows a participant to join a public conference, wherein a degraded version of the participant's image and no sound from the participant will be available to other conference participants of the public conference. The participant may, while being in the public conference, engage in a private session with a subgroup of the conference participants. The participant's image and sounds from the participant will be available to the subgroup in the private session in normal quality at the same time that the degraded version of the participant's image is made available to conference participants who are in the public conference but not the private session.

### CROSS-REFERENCE TO RELATED APPLICATION(S)

This patent application claims the benefit o U.S. Provisional Patent Application No. 62/423,706 that was filed on Nov. 17, 2016, the content of which is incorporated by reference herein.

### FIELD OF INVENTION

The present disclosure relates generally to virtual conferencing and more particularly to virtual conferencing that allows participants to communicate via concurrent private sessions.

### BACKGROUND

Virtual conferencing in the form of video conferencing has become widely available in the past decade. Video conferencing provides a convenient way for participants to “meet” without traveling to be physically together. Usually, current video conferencing systems are designed for real time audio and video communications among all conference participants. In some meetings, however, participants prefer communicating with each other mainly in multiple concurrent private sessions. An example in real life is a networking event, where participants usually hold private conversations within small private groups. Participants can freely leave a private group and form or join another private group. Most of the time, participants' communications with peers are limited within the private groups and are not shared with the whole networking event group. Other real life examples include job fairs and group dating events where attendants hold face-to-face private conversations to find out more about each other. There is a need for a virtual conferencing system that can meet the challenge presented by concurrent private sessions, especially when the number of participants are large.

### SUMMARY

This inventive concept pertains to a virtual conferencing system that allows participants of a large public conference to communicate with each other in multiple concurrent private sessions.

In one aspect, the disclosure pertains to a method of virtual conferencing that allows a participant to join a public conference, wherein a degraded version of the participant's image and no sound from the participant will be available to other conference participants of the public conference. The participant may, while being in the public conference, engage in a private session with a subgroup of the conference participants. The participant's image and sounds from the participant will be available to the subgroup in the private session in normal quality, such that the participant's image and sounds are made available to the subgroup simultaneously while the degraded version of the participant's image is made available to conference participants who are in the public conference but not the private session.

In another aspect, the disclosure pertains to a system for virtual conferencing. The system includes a memory that stores a first list of public conference participants including Participant A and a second list of private session participants including Participant A. A processor makes available a degraded image of the Participant A without audio to public conference participants on the first list and, at the same time, makes available a normal image of the Participant A with audio to the private session participants on the second list.

### DESCRIPTION OF THE DRAWINGS

FIGS. 1A, 1B and 1C depict embodiments of a virtual conferencing system in accordance with the inventive concept.

FIGS. 2A, 2B, 2C and 2D show the screens of four imaginary conference participants at a particular moment.

FIGS. 3A, 3B, 3C and 3D show the screens of four imaginary conference participants after the conference host becomes a public speaker.

FIGS. 4A, 4B, 4C and 4D show the screens of four imaginary conference participants after the conference host accepts a participant's request to be a public speaker.

FIGS. 5A and 5B show the screens of two imaginary conference participants in the first part of an asynchronous response sequence.

FIGS. 6A and 6B show the screens of two imaginary conference participants in a synchronous response sequence.

FIGS. 7A and 7B show the screens of two imaginary conference participants in the second part of an asynchronous response sequence.

FIGS. 8A and 8B show the screens of two imaginary conference participants in an introduction sequence.

### DETAILED DESCRIPTION

The present disclosure pertains to a method and system that builds on public-private duality, handles real time audio and video communication based on a private-until-shared principle and uses a hybrid synchronous/asynchronous response mechanism to handle certain requests among participants. In one aspect, the disclosure pertains to a method of conducting a virtual conference by allowing participants to join a group and see other participants in the group, and creating and managing multiple private sessions to happen among the participants. Although the concept will be described in the context of a virtual conference, it will be understood that this is not a limitation of the disclosed method and system, and the concepts disclosed herein can be adapted to other applications, such as virtual games.

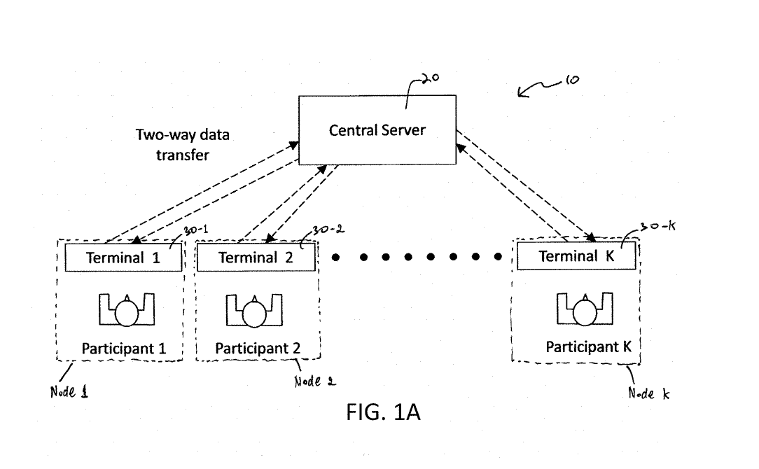

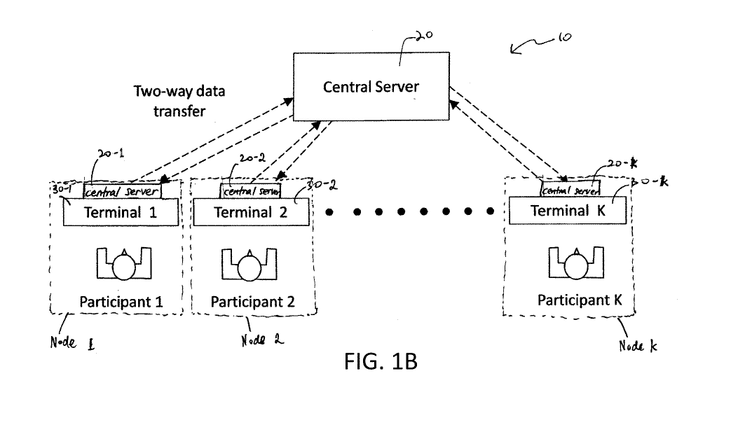

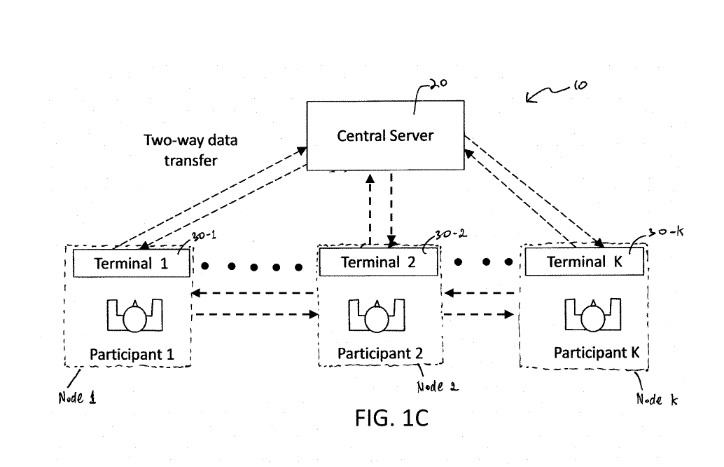

FIG. 1A depicts a virtual conferencing system 10 of the inventive concept. A “conference”, as used herein, is intended to include any type of meeting or exchange and is not limited to a formal business meeting. A “virtual conference” is intended to include any type of meeting or exchange that does not require participants to be in the same physical location, such as a video conference, screen sharing, and audio conference. As shown in FIG. 1A, the virtual conferencing system 10 includes a central server 20 and a plurality of terminals 30. “Real time,” as used herein, mean simultaneously as the live action, typically with less than one second lag.

The central server 20 can include a web server, an enterprise server, or any other type of computer server, and can be computer programmed to accept requests (e.g., HTTP, or other protocols that can initiate data transmission) from a computing device and to serve the computing device with requested data. In addition, the central server 20 can be a broadcasting facility, such as free-to-air, cable, satellite, and other broadcasting facility, for distributing data.

The terminals 30 can include a room system, a desktop computer, a laptop, a tablet, a smartphone, or any other device capable of capturing, displaying, and transmitting visual data and audio data. Each terminal 30 is equipped with audio and video input and output devices, and each terminal 30 may have a participant. A “participant” may be a human being, a robot, a virtual cartoon figure, an inanimate object, a white board, a presentation, etc. The video input/output devices at the terminals 30 allow the participants to see each other, and the audio input/output devices at the terminals 30 allow the participants to hear each other. The terminals 30 may be at remote geographical locations (e.g., different cities), although this is not a limitation of the inventive concept.

The virtual conferencing system 10 may include a plurality of nodes. Each terminal 30 in the virtual conferencing system 10 corresponds to a “node.” If a “terminal 30” is followed by a number or a letter, it means that the “terminal 30” corresponds to a node sharing the same number or letter. For example, as shown in FIG. 1A, terminal 30-1 corresponds to node 1 which is associated with participant 1, and terminal 30-k corresponds to node k which is associated with participant k.

A “node” is a logically independent entity in the virtual conferencing system 10. Therefore, the plurality of nodes in the virtual conferencing system 10 can represent different entities. For example, a node may be associated with a conference participant, a projection screen, a white board, an empty seat, or even an empty space. A node may also be a simulation of a virtual conference terminal from another system, thereby allowing participants using different systems to engage in a conference. A node may correspond to multiple objects. For example, a projection screen and a white board can share the same node. In such a case, a conference participant can elect whether to display the projection screen and/or white board on his terminal 30. Not every node corresponds to a terminal 30, however. For example, the white board node may be a board that is generated by the central server 20.

Referring to FIG. 1A, the bi-directional arrows between the central server 20 and each terminal 30 indicate two-way data transfer capability between the central server 20 and each terminal 30. The terminals 30 can communicate with one another via the central server 20. For example, both visual data and audio data may be transmitted to/from the terminals 30 and the central server 20, and among the terminals 30. The central server 20 collects (visual and/or audio) data from each terminal 30, and generates an appropriate custom view to present at each of the other terminals 30.

FIG. 1B is another embodiment of the virtual conferencing system 10, and illustrates that the central server 20 does not have to be one physical unit at one location. The central server 20 is defined by its processing capability, and can thus be partially remote to the terminals 30 and partially located at the terminals 30. For example, as shown in FIG. 1B, the system 10 can further include a plurality of central servers (20-1, 20-2, . . . , 20-k) located at respective terminals (30-1, 30-2, . . . , 30-k), in addition to a central server 20.

FIG. 1C is yet another embodiment of the virtual conferencing system 10. Unlike the embodiments of FIG. 1A and FIG. 1B, which employ a client-server architecture, the embodiment of FIG. 1C employs a peer-to-peer communication channel by which terminals 30 can directly communicate without passing through the central server 20. The peer-to-peer communication channel helps reduce the load on the central server 20 by utilizing the resources (e.g., bandwidth, storage space, processing power) of the network participants (terminals 30). Although not explicitly shown, the peer-to-peer communication channel may be added to the embodiment of FIG. 1B where the central server 20 is not in one location. The peer-to-peer channel may be especially useful in certain situations, such as in a two-participant conference.

### Public-Private Duality

The virtual conferencing system disclosed herein builds on the concept of public-private duality, meaning that a participant can be in a public session and a private session at the same time. Any participant who joins a virtual conference is first placed in the public session and remains in the public session throughout the virtual conference whether or not she is in a private session. Basic information such as each participant's name, self-description, social media profile (if the participant chooses to share such) and the participant's status (whether the participant is a host, whether the participant is in a private session, etc.) will be shared with other participants.

Real time audio and video communication via the public session is kept to a minimum. As long as a participant is not a public speaker, the participant's real time audio and normal video are not shared with any participant via the public session. Instead, degraded video (no audio) is shared with other participants. As used herein, a “normal video” has characteristics that people would normally expect from video communication in terms of image resolution, noise level, color, sharpness, contrast, brightness, frame rate, etc. A “normal video” is expected to enable an ordinary person to tell facial features of people in the video and infer what they are doing with reasonable accuracy. A “degraded video” of a participant is intended to let other participants know the availability and readiness of the participant for live communication via real time audio and video in the virtual conference. At a minimum, a degraded video is expected to enable an ordinary person to tell if someone is present in the video. A degraded video may enable an ordinary person to recognize facial features of people in the video or infer what they are doing with reasonable accuracy, but not both. One example of a degraded video is a blurred video in which continuous motion of a person can be sensed but that person's facial features are hardly recognizable. Another example of a degraded video is a video in which each video frame is a black and white thumbnail snapshot with reasonably recognizable facial features but the video frames are only refreshed every ten seconds such that an ordinary person cannot sense continuous motion by looking at the video frames in succession. An extreme example of a degraded video is a static photo with reasonably recognizable facial features that never gets refreshed. Sharing degraded video via the public session not only serves the purpose of protecting participants' privacy, but also helps in managing network bandwidth when the number of participants increases.

The public session provides a place for participants to browse each other's basic information and hang out before entering private sessions with other participants. Because all participants remain in the public session throughout the conference, the public session allows participants to convey certain information to each other whether or not they are in private sessions. In one embodiment, a participant not in a private session may send another participant not in a private session a digital request to start a private session and then enter the private session if the request is accepted. In another embodiment, a participant not in a private session may send a digital request to participants already in a private session to join the private session and then enter the private session if the request is accepted. In yet another embodiment, a participant not in a private session may receive an invitation from another participant to either start or join a private session and then enter the private session by accepting the invitation. In yet another embodiment, a first participant in a first private session may send a digital request to a second participant in a second private session to invite the second participant to join the first private session; once the second participant accepts the request, the second participant will be removed from the second private session and be placed in the first private session; this is especially useful when the first participant wants to introduce the second participant to others in the first private session.

In a private session, a participant's real time audio and normal video are automatically shared with any participant in the same private session, but not with any participant outside the private session. The participant may still manually turn off real time audio or normal video sharing within the same private session if she chooses to do so. The fact that the participant is in a private session might be shared with participants outside the private session. Certain information regarding the private session, such as the number of participants in the private session, names of participants in the private session and the starting time of the private session, might also be shared with participants outside the private session.

### Private-Until-Shared Principle

Contrary to traditional virtual conferencing systems, the inventive concepts disclosed herein handle real time audio and video communication based on a private-until-shared principle. The private-until-shared principle dictates that a participant's real time audio and normal video will not be shared with other participants unless the participant chooses to do so and if a participant is sharing her real time audio and normal video she may terminate the sharing any time without leaving the public session. The private-until-shared principle applies to audio and video communications via both the public session and private sessions.

In one embodiment, a participant may accept a request from the conferencing system or a current public speaker to become a public speaker. Alternatively, a participant may request to be a public speaker and send the request to the conferencing system or a current public speaker. Such a request may be accompanied by credentials that verify the participant's eligibility to be a public speaker, such as a passcode. If the request is accepted by either the conferencing system or the current public speaker, the participant becomes a public speaker. As a public speaker, the participant's real time audio and normal video will be shared via the public session with all participants in the virtual conference. The participant may terminate her role as a public speaker any time. Depending on system configuration, the conferencing system or another public speaker may also be able to terminate the participant's role as a public speaker. Upon such termination, unless the participant chooses to immediately share her real time audio and normal video thereafter (for example, by entering a private session), her real time audio and normal video will no longer be shared with any participant in the virtual conference.

In another embodiment, a participant may accept a request from another participant to enter a private session; alternatively, a participant may send a request to another participant to start or join a private session and the other participant accepts such a request. In both cases, the participant will enter a private session and her real time audio and normal video will be shared with any participant in the same private session, but not with any participant outside the private session. The participant may leave the private session any time; sometimes the participant may have to leave the private session because all other participants have left the session; the participant may also be forced to leave the private session if a mechanism exists that allows either the conferencing system or other participants in the private session to exercise such an option. In all cases, unless the participant chooses to immediately share her real time audio and normal video thereafter (for example, by becoming a public speaker or entering a different private session), her real time audio and normal video will no longer be shared with any participant in the virtual conference.

The conferencing system may send notifications to remind a participant when her real time audio and normal video are shared with others either via the public session or via a private session. For example, the conferencing system may choose to display text such as “I am looking at you!” in front of or in the vicinity of a representation of a peer participant with whom the participant's real time audio and normal video are shared. Alternatively, a cartoon figure, such as a red bird, or an eye icon, can be displayed in front of or in the vicinity of a representation of a peer participant to convey the same message that “I am looking at you!”. A representation of a participant, as used herein, refers to things that identify with the participant on another participant's display screen. Examples of representations include name tag, photo or video (normal or degraded) of the participant. The conferencing system will withdraw the notifications once the participant's real time audio and normal video are no longer shared with other participants.

The private-until-shared principle keeps a participant's real time audio and normal video to herself unless she knowingly share her real time audio and normal video with all participants (via the public session in the case of becoming a public speaker) or a selected group of participants (via a private session in the case of entering a private session). The private-until-shared principle not only helps to protect the privacy of a participant, but also minimizes unexpected distractions from those who are not engaged in a conversation with the participant.

A transition mechanism may be put in place before a participant's real time audio and normal video are shared with other participants. In one embodiment, when a first participant enters a private session with a second participant, a transition period starts. During the transition period, the two participants only share with each other real time audio and degraded video. If neither participant leaves the private session after the transition period has ended, the two participants will share with each other real time audio and normal video. In some cases, during the transition period, more and more visual details might be revealed in the degraded video in a progressive manner until the normal video is shared. The progressive revelation of visual details might be realized by gradually improving, either sequentially or concurrently, one or more of the video quality parameters such as image resolution, noise level, color, sharpness, contrast, brightness, frame rate, etc. For example, both the image resolution and the frame rate might gradually get higher in the degraded video during the transition period, such that the video reaches a normal video resolution and frame rate by the end of the transition period. The transition mechanism may make some participants more comfortable to enter private sessions by letting private session participants interact mainly via real time audio first before sharing normal video.

### Hybrid Synchronous/Asynchronous Response Mechanism

One of the main functions of a virtual conference is to allow participants to convey information to others. A target participant, as used herein, is a peer participant to whom a participant wants to convey information. The participant who wants to convey information will be referred to as the originating participant. The information conveying may be intended as a unilateral (e.g., one-way) process, meaning that the originating participant does not expect a response from the target participant. The information conveying may also be intended as a bilateral (e.g., two-way exchange) process, meaning that the originating participant expects a response from the target participant.

An originating participant may unilaterally convey information to a target participant who is in a private session (assuming the originating participant is not already in the same private session) in real time audio and normal video via the public session by becoming a public speaker, if doing so is allowed by the conferencing system or a current public speaker. In this case, the originating participant's real time audio and normal video are shared not only with the target participant, but also with all other participants in the virtual conference. The target participant in the private session will be able to hear the real time audio and see the normal video of the originating participant but will not able to respond to the originating participant in real time audio and normal video because the target participant's real time audio and normal video are only shared within the private session.

If the originating participant is unable or unwilling to become a public speaker, some embodiments may allow her to still convey information unilaterally to the target participant in private session in forms other than real time audio and normal video, such as text message, audio message, video message, etc. The information may be delivered to the target participant only and not shared with other participants.

The originating participant may want to convey information to the target participant in private session and expect a response. For example, the originating participant may ask if the target participant is willing to start a new private session. Because public-private duality enables the target participant to remain in the public session even after the current private session ends, the target participant has some flexibility in delivering a response. The virtual conferencing system may present options such that the target participant may respond immediately (synchronous) or respond after the target participant leaves the private session (asynchronous). In the case of a synchronous response, the conferencing system will deliver the target participant's response to the originating participant immediately. In the case of asynchronous response, the conferencing system will notify the originating participant that the target participant will respond after leaving the current private session; once the target participant responds, the conferencing system will deliver the response to the originating participant. In some cases, the conferencing system may default to synchronous response only (for example, if the originating participant is inviting the target participant to join an existing private session to introduce the target participant to someone) or asynchronous response only (for example, if the target participant already has multiple requests to respond to). The conferencing system may also default to asynchronous response if the target participant did not produce a synchronous response within a reasonable amount of time (for example, 15 seconds). If the target participant chooses asynchronous response or if the conferencing system defaults to asynchronous response, the conferencing system will create a queue where the originating participants' requests for response are stored. Once the target participant leaves the private session, the conferencing system will enable the target participant to respond to the requests in the queue, either in the order of the requests, or in another order.

Sometimes, the target participant may also need the originating participant to respond to the asynchronous response. For example, the originating participant may ask if the target participant in private session is willing to start a new private session. The target participant decides to respond after leaving her current private session. The conferencing system notifies the originating participant and the originating participant moves on to start a private session with a third participant. When the target participant leaves her private session, she produces an asynchronous response that she is willing to start a new private session with the originating participant. Because the originating participant is now in a private session with the third participant, the conferencing system will present the originating participant with options either to stay in the current private session or start a new private session with the target participant as she originally requested. A grace period will be provided to give the originating participant time to make a decision and also enable the originating participant to end current private session gracefully if she chooses to start a new private session with the target participant. To avoid conflict in availability, during the grace period, the conferencing system will keep the target participant from initiating or accepting a request to enter a private session with other participants. If the originating participant decides to stay in the current private session or does not make a decision by the end of the grace period, the conferencing system will notify the target participant so that the target participant can move on to the next task, such as processing the next request in queue or starting a private session with another participant. If the originating participant decides to start a new private session with the target participant by the end of the grace period, the conferencing system will remove the originating participant from her current private session and put her into a new private session with the target participant.

If a participant has a queue of requests to respond to, whether the participant is still in a private session or is in the process of responding to requests in the queue, the conferencing system may share certain information regarding the queue (for example, how many requests are in the queue, who are the originating participants of the requests, etc.) with other participants. In one embodiment, the number of requests in the queue may be displayed in front of or in the vicinity of a representation of the participant. In another embodiment, a number of human shaped icons may be displayed in front of or in the vicinity of a representation of the participant to create a sense of bustling crowd. Sharing the information regarding a participant's queue of requests to respond to may help another participant decide whether she wants to send her own request to the participant.

With the hybrid synchronous/asynchronous response mechanism, an originating participant will be able to enter private sessions with other participants before the target participant leaves her current private session and responds to the originating participant's request. It will also help any participant in a private session decide when to leave the current session based on the number of queueing requests. The originating participant can avoid wasting time just to wait for the target participant; meanwhile, the target participant does not have to abruptly leave a private session just to respond to a new request.

The hybrid synchronous/asynchronous response mechanism may also be useful in the situation where an originating participant sends a request to a target participant who is a public speaker. The target participant may choose to respond to a request from the originating participant either immediately (synchronous response) or after terminating the public speaker role (asynchronous response).

### Flexibility in Implementing Public-Private Duality

A virtual conference may implement public-private duality throughout the conference. It may also implement public-private duality during certain periods of the conference; during other periods, the conference can fall back to the more traditional video conference where all participants' real time audio and normal video are shared with each other. For example, a conference may start as a traditional video conference to have a discussion among a large group of participants and then switch to public-private duality so that people can further exchange ideas in small groups.

### Extending Duality to Multiplicity

It should be understood that “public” and “private” are relative concepts. In the context of a large networking event, sharing with the whole networking group is considered as “public” and sharing within a private session is considered as “private”. However, in the context of a private session that has multiple people, sharing with everyone in the private session might be considered “public” and sharing with only one of the participants within the private session might be considered “private”.

The duality concept can be extended to multiplicity with multiple levels of privacy. Starting from the public session, multiple layers of private sessions can be created. The first layer of private sessions are first created within the public session; the second layer of private sessions are then created within the first layer of private sessions; and so on. In general, inner layer sessions have less privacy control than outer layer sessions; a participant in an inner session also belongs to an outer session within which the inner session is created; any audio or video shared in an outer session will be automatically shared with participants in any inner sessions within that outer session.

In one embodiment, a first layer of private sessions called “group sessions” are created within the public session; then a second layer of private sessions called “unit sessions” are created within each group session. This creates a three layer system: the public session, group sessions and unit sessions. As long as a participant is not a public speaker, only the participant's degraded video (no audio) is shared with other participants via the public session. A public speaker's real time audio and normal video are shared with all participants via the public session. Within each group session, as long as a participant is not a group speaker, the participant's real time audio (but not normal video) is shared with other participants in the group session, but not with anyone outside the group session. A group speaker's real time audio and normal video are shared with all participants in the group session, but not with anyone outside the group session. Within each unit session, a participant's normal video is shared with other participants in the unit session, but not with anyone outside the unit session. A participant in a unit session may see the normal video of all participants in the same unit session, hear the real time audio of all participants in the group session within which the unit session is created and see the degraded video of all participants in the public session; this participant may also hear the real time audio and see the normal video of any public speaker and any group speaker within her group session (but not group speakers in other group sessions). A participant in a group session but not in a unit session may hear the real time audio of all participants in the same group session and see the degraded video of all participants in the public session; this participant may also hear the real time audio and see the normal video of any public speaker and any group speaker within her group session (but not group speakers in other group sessions). A participant in a public session but not in a group session may see the degraded video of all participants in the public session; the participant may also hear the real time audio and see the normal video of any public speaker.

### Grouping of Participants

The virtual conferencing system may put participants in different groups using certain criteria. Some criteria are based on the characteristics of the participants themselves, not based on the relations among participants. In one embodiment, if a virtual conference is intended for an online group dating event, a participant might be put into either the male group or the female group. In another embodiment, if a virtual conference is intended for an online job fair, a participant might be put into either the job seeker group or the employer group. Some other criteria are based on the relations among participants. In one embodiment, for a participant, other participants might be divided into two groups based on whether they have or have not been in a private session with the participant. In another embodiment, for a participant, other participants might be divided into two groups based on whether the participant has blocked them or not. In yet another embodiment, the virtual conferencing system can identify users based on login credentials and track their history in previous virtual conferences using the same login credentials. For a participant, the conferencing system may divide other participants into groups based on whether they have or have not been in private sessions with the participant in previous virtual conferences, whether or not they are connected with the participant on social media, etc.

The virtual conferencing system may adjust how the participants are displayed at each terminal based on the grouping of participants. In one embodiment, participants in the employer group might be displayed in a more prominent way at terminals corresponding to participants in the job seeker group. In another embodiment, when a participant is browsing the basic information of other participants after leaving a private session, the group of participants that have not been in a private session with the participant might be displayed in a more prominent way at the terminal corresponding to the participant. In yet another embodiment, when a participant tries to invite other participants to join a current private session, the group of participants that are already connected with the participant on social media might be displayed in a more prominent way at the terminal corresponding to the participant.

### AN EXAMPLE

An example is provided to illustrate the concepts described in this disclosure. The example is not intended to limit the scope of this inventive concept.

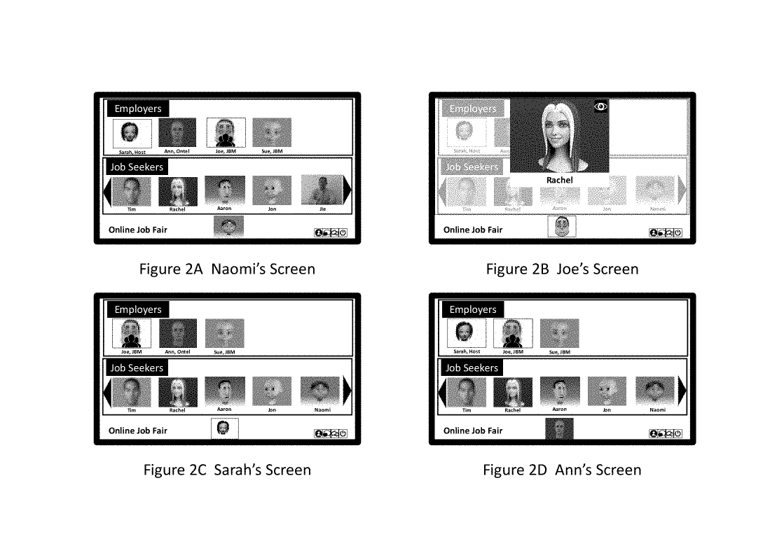

In the example, a virtual conference provides a place for employers and job seekers to interact with each other in an online job fair. The host of the virtual job fair is Sarah. Three employer representatives (Ann from Ontel, Joe from JBM and Sue from JBM) and numerous job seekers (Tim, Aaron, Jon, Rachel, Naomi and others) attend the job fair. FIGS. 2A, 2B, 2C and 2D show the snapshots of the screens of Naomi, Joe, Sarah and Ann, respectively, at a particular moment. In this embodiment, the video of the participant who is watching the screen is shown at bottom center. From FIGS. 2A, 2C and 2D, it can be seen that Naomi, Sarah and Ann are not in private sessions. Degraded videos of participants are displayed on their screens. The human shaped icon in Joe's video window indicates that people are queuing up for private sessions with him. From FIG. 2B, it can be seen that Joe is in a private session with Rachel. The eye icon on the top right of Rachel's normal video indicates that Rachel is watching Joe's normal video.

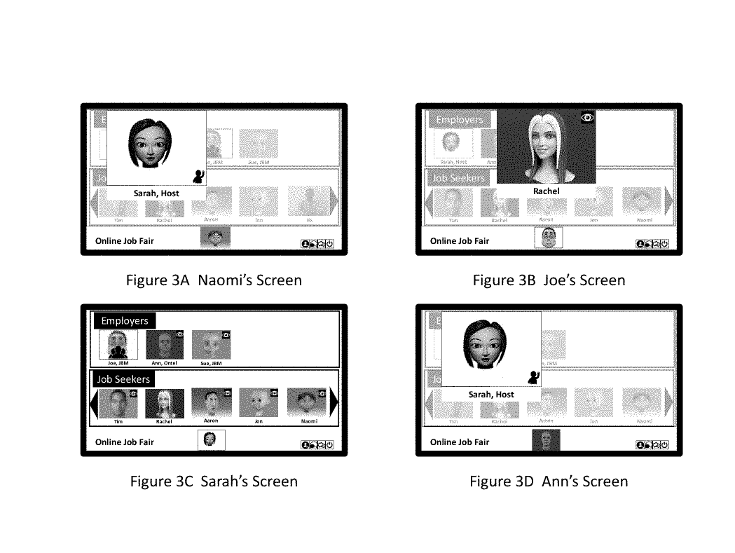

FIGS. 3A, 3B, 3C and 3D show the snapshots of the screens of Naomi, Joe, Sarah and Ann, respectively, after Sarah becomes a public speaker. It can be seen from FIGS. 3A and 3D that both Naomi and Ann are watching Sarah's normal video. A participant may request to have a public conversation with Sarah by clicking the hand raising icon at the bottom right of Sarah's video window. In FIG. 3B, Joe is still looking at Rachel's normal video, although he can hear Sarah's real time audio. He may also watch Sarah's normal video if he chooses to do so (not shown in FIG. 3B) because as a public speaker, Sarah's real time audio and normal video are available to all participants in the conference. FIG. 3C shows that Sarah is not looking at any particular participant. The eye icons in the video windows of all participants except Joe and Rachel indicate that most participants are watching Sarah's normal video. The eye icons are missing from Joe and Rachel's video windows because Joe and Rachel are watching each other's normal videos in a private session.

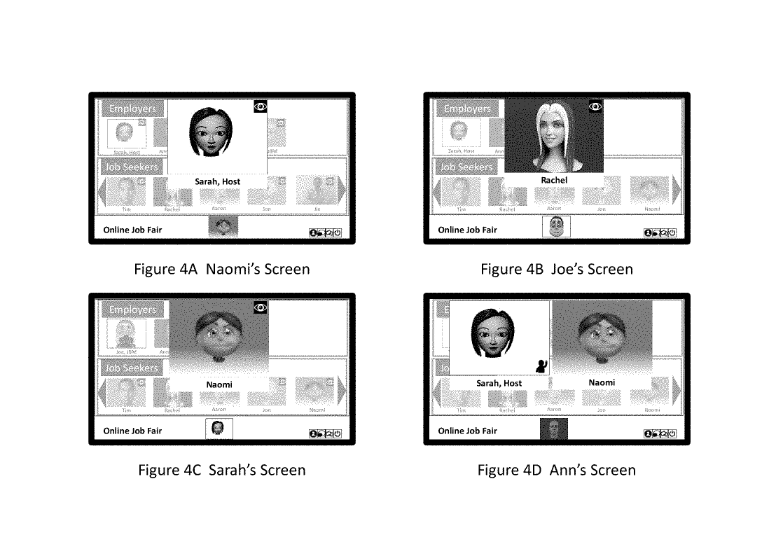

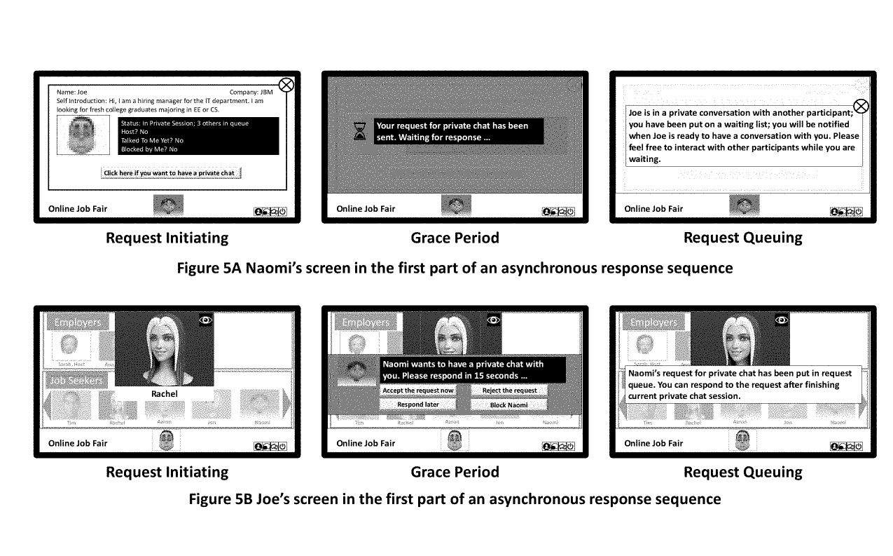

After Sarah gives a general introduction of the job fair, she asks participants to raise their hands if they want to introduce themselves to everyone. Naomi clicks the hand raising icon to let Sarah know her intention to become a public speaker. FIGS. 4A, 4B, 4C and 4D show the snapshots of the screens of Naomi, Joe, Sarah and Ann, respectively, after Sarah accepts Naomi's request to be a public speaker. Naomi can tell that Sarah is watching her normal video from the eye icon in Sarah's video window (FIGS. 4A). She can also tell that most participants are watching her normal video now from the eye icons in the video windows of all participants except Joe and Rachel. So Naomi starts to introduce herself In FIG. 4B, Joe is still looking at Rachel's normal video in their private session, although he can hear the real time audio of both Sarah and Naomi. He may also watch Sarah and Naomi's normal videos if he chooses to do so (not shown in FIG. 4B) because as public speakers, Sarah and Naomi's real time audio and normal video are available to all participants in the conference. Sarah sees from her own screen (FIG. 4C) that Naomi and most other participants are watching her normal video from the eye icons in the video windows of all participants except Joe and Rachel. Ann sees from her own screen (FIG. 4D) normal videos of both Sarah and Naomi.

After Naomi finishes introducing herself, she terminates her public speaker role and starts to browse basic information of other participants. She reviews Joe's information and decides to send Joe a request for private session despite the fact that there are already three people waiting to talk to Joe. FIGS. 5A and 5B show Naomi's and Joe's screens in the first part of an asynchronous response sequence. At “Request Initiating” stage, Naomi clicks the “Click here if you want to have a private chat” button to send Joe a request for private session. During a 15-second grace period, Joe sees on his screen that Naomi is requesting a private session and is presented with options such as “Accept the request now”, “Reject the request”, “Respond later” and “Block Naomi”. In the meantime, Naomi is prevented from sending other requests and gets a message that the conferencing system is waiting for response. At “Request Queuing” stage, Joe clicks the “Respond later” button and sees a system message that Naomi's request has been placed in a request queue. The conferencing system also notifies Naomi immediately that her request has been placed in a queue and Joe will respond later.

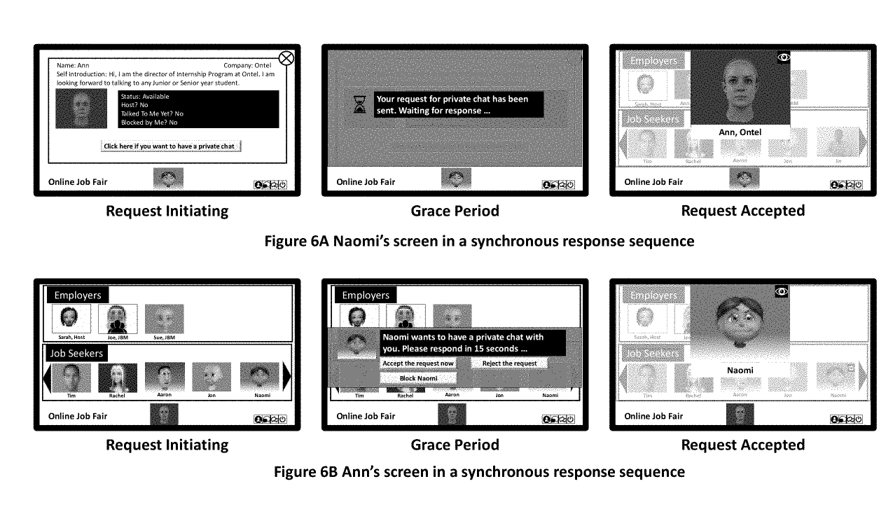

While waiting for Joe's response, Naomi continues browsing information of other participants. As Ann is immediately available, Naomi decides to send Ann a request for private session. FIGS. 6A and 6B show Naomi's and Ann's screens in a synchronous response sequence. At “Request Initiating” stage, Naomi clicks the “Click here if you want to have a private chat” button to send Ann a request for private session. During a 15-second grace period, Ann sees on her screen that Naomi is requesting a private session and is presented with options such as “Accept the request now”, “Reject the request”, and “Block Naomi”. Because Ann is neither a public speaker nor in a private session, the option “Respond later” is not available for Ann. In the meantime, Naomi is prevented from sending other requests and gets a message that the conferencing system is waiting for response. At “Request Accepted” stage, Ann clicks the “Accept the request now” button and enters a private session with Naomi. Ann now sees Naomi's normal video on her screen. The eye icon on top right of Naomi's video window indicates that Naomi is also watching her normal video. Naomi also immediately sees Ann's normal video with an eye icon indicating that Ann is watching her normal video.

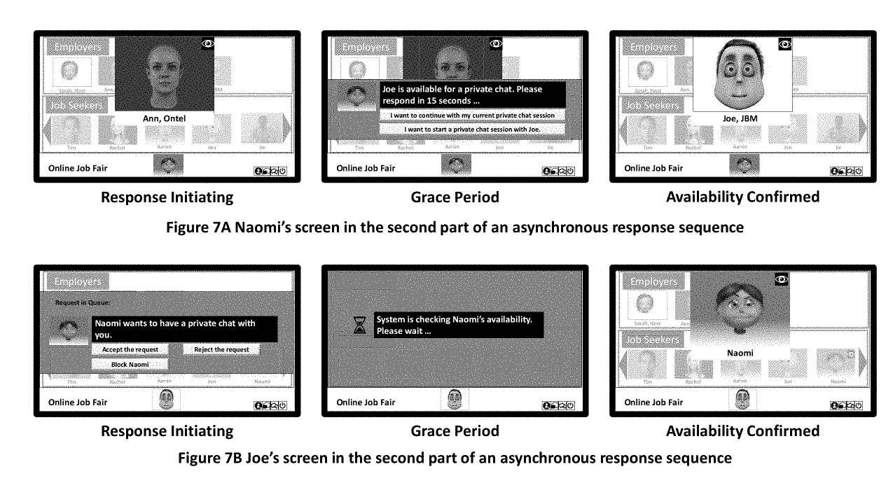

During Naomi's private session with Ann, Joe finishes his private session with Rachel and starts to process requests in the queue and decides to accept Naomi's previous request for private session. FIGS. 7A and 7B show Naomi's and Joe's screens in the second part of an asynchronous response sequence. At “Response Initiating” stage, Joe is presented with options such as “Accept the request”, “Reject the request” and “Block Naomi”. Joe clicks the “Accept the request” button. During a 15-second grace period, Naomi sees on her screen that Joe is available for private session and is presented with the options to either stay in current private session or enter a private session with Joe. In the meantime, Joe is prevented from sending or processing other requests and gets a message that the conferencing system is checking Naomi's availability. At “Availability Confirmed” stage, Naomi quickly wraps up her conversation with Ann before the grace period ends and clicks the “I want to start a private chat session with Joe” button to enter a private session with Joe. Naomi now sees Joe's normal video on her screen. The eye icon on top right of Joe's video indicates that Joe is also watching her normal video. Joe immediately sees Naomi's normal video with an eye icon indicating that Naomi is watching his normal video now.

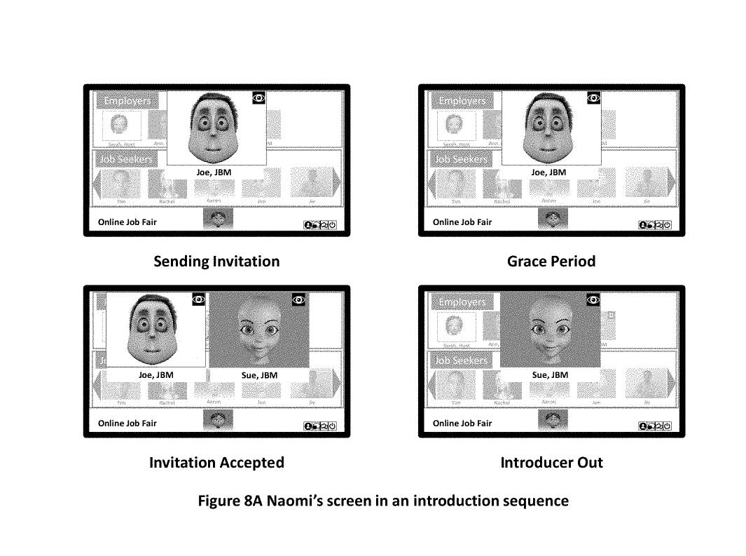

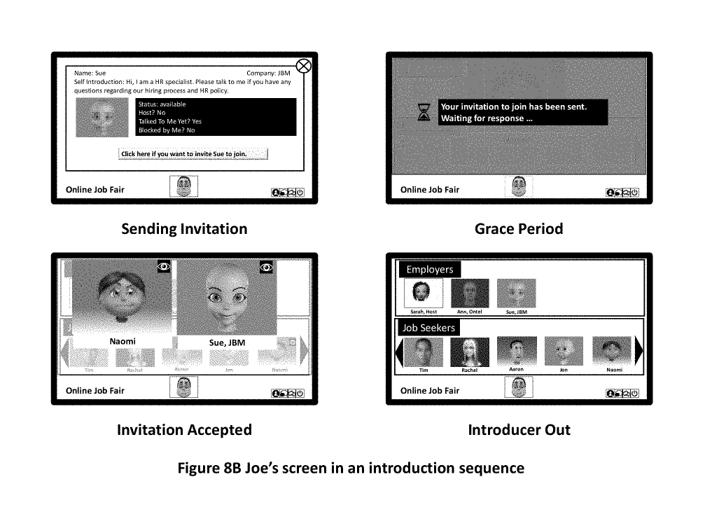

After Joe talks to Naomi, he wants to introduce Naomi to another representative from JBM, Sue. FIGS. 8A and 8B show Naomi's and Joe's screens in an introduction sequence. At “Sending Invitation” stage, Joe clicks an introduction icon at the bottom right of his screen to bring up Sue's basic information. Joe then clicks the “Click here if you want to invite Sue to join” button to send Sue an invitation to join his current private session. During a 15-second grace period, Sue sees on her screen that Joe is inviting her to join a private session and is presented with the option to either accept or reject the invitation (not shown in the figures). In the meantime, Joe is prevented from sending other requests and gets a message that the conferencing system is waiting for response. At “Invitation Accepted” stage, Sue accepts the invitation. Joe and Naomi immediately see Sue's normal video. The eye icons in Sue's video windows indicate that Sue is watching normal videos of both Joe and Naomi. At “Introducer Out” stage, Joe leaves the private session and goes back to the public session. Naomi now only sees Sue's normal video on her screen. Sue also only sees Naomi's normal video on her screen (not shown in the figures). The introduction is successfully made.

Embodiments of the inventive concepts and all of the functional operations described in this specification can be implemented in digital electronic circuitry, or in computer software, firmware, or hardware, including the structures disclosed in this specification and their structural equivalents, or in combinations of one or more of them. The central server can be implemented as a combination of computer hardware including a processor and a memory with one or more computer program products, i.e., one or more modules of computer program instructions encoded on a computer-readable medium for execution by, or to control the operation of, data processing apparatus. In one embodiment, the central server (e.g., in its memory) may store and maintain a first list of participants in the public session and a second list of participants in a private session. There may be many private sessions going on simultaneously, and the central server will continuously update the list of participants in each of the private sessions. If Participant A is in the public session and a private session, her degraded image (without audio) and her normal video are simultaneously made available to the public session participants and the private session participants, respectively.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction among terminals 30, embodiments can be implemented using a computer having a display device, e.g., a CRT (cathode ray tube), LCD (liquid crystal display), projection screen, OLED display, 3D display, etc. for displaying information to the participants. A keyboard and a pointing device, e.g., a mouse or a trackball, by which a conference participant can provide input to the computer are also provided. Other kinds of devices can be used to provide for interaction with participants as well; for example, feedback provided to the user can be any form of sensory feedback, e.g visual feedback, auditory feedback, or tactile feedback; and input from the user can be received in any form, including acoustic, speech, brain waves, other physiological input, eye movements, gestures, body movements, or tactile input. For example, any of the above methods may be used to make a “selection.”

Embodiments can be implemented in a computing system that includes a back-end component, e.g., as the central server 20, or that includes a middleware component, e.g., an application server, or that includes a front-end component, e.g., a computer at a terminal 30 having a graphical user interface or a Web browser through which a user can interact with an implementation of the invention, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The virtual conferencing system can include clients and servers. A client and server are generally remote from each other and typically interact through a communication network. In the example embodiments presented above, the terminals 30 may be a type of “client.” The relationship of client and server arises by virtue of computer programs running on the respective computers and having a client-server relationship to each other.

While this specification contains many specifics, these should not be construed as limitations on the scope of the invention or of what can be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the embodiments described above should not be understood as requiring such separation in all embodiments, and it should be understood that the described program components and systems can generally be integrated together in a single software product or packaged into multiple software products.

It should be understood that the inventive concept can be practiced with modification and alteration within the spirit and scope of the disclosure. The description is not intended to be exhaustive or to limit the inventive concept to the precise form disclosed.

What is claimed is:

1. A method for virtual conferencing, comprising:
allowing a participant to join a public conference, wherein a degraded version of the participant's image and no sound from the participant will be available to other conference participants of the public conference;
allowing the participant to, while being in the public conference, engage in a private session with a subgroup of the conference participants, wherein the participant's image and sounds from the participant will be available to the subgroup in the private session in normal quality, such that the participant's normal image and sounds are made available to the subgroup simultaneously while the degraded version of the participant's image is made available to conference participants who are in the public conference but not the private session.

2. A system for virtual conferencing, comprising:
a memory that stores a first list of public conference participants including Participant A;
a processor that makes available a degraded image of the Participant A without audio to other public conference participants;
a memory that stores a second list of private session participants including Participant A, wherein the processor makes available a normal image of the Participant A with audio to private session participants at the same time the degraded image of the Participant A without audio is being shared with other public conference participants who are not included in the second list.
